(19) United States
(12) Patent Application Publication
(10) Pub. No.: US 2011/0026213 A1
(43) Pub. Date: Feb. 3, 2011

(54) MEMORY CARD WITH SATA CONNECTER

(76) Inventors: Kai-Shun Chang, Taipei City (TW); Yu-Chieh Chang, Taipei City (TW); Chi-Liang Tsai, Taipei City (TW); Chien-Cheng Yu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/702,255

(22) Filed: Feb. 8, 2010

(30) Foreign Application Priority Data
Jul. 31, 2009 (TW) 098125878

(51) Int. Cl. G06F 1/16; H01R 12/00

(52) U.S. Cl. 361/679.31; 439/65

(57) ABSTRACT

A memory card with a SATA connecter includes a SATA connector, a memory module, a controller, and a power control circuit. The SATA connector of the memory card is used for being connected with an electronic device. The SATA connector includes nine pins for receiving electric power, identifying a SATA interface signal, transmitting the SATA interface signal, and being connected with ground. The controller is electrically connected with the SATA connector and the memory module to control the data transmission between the memory card and the electronic device. The power control circuit is electrically connected with the connector, the memory module, and the controller to provide the electric power needed by the memory card.

### BACKGROUND OF THE INVENTION

1. Field of the Invention

The invention relates to a memory card and, more particularly, to a memory card with a serial advanced technology attachment (SATA) transmission interface.

2. Description of the Related Art

With the advancement of information technology and the development of and computer technology, a computer system becomes smaller and smaller, and the usage of the computer system becomes more and more diversified. To expand the function of the computer system to meet different demands of different users, various kinds of external devices for the computer system are developed correspondingly. For example, an external hard disk or a portable storage device such as a removable memory card (such as a secure digital (SD) card, a CF card, a multimedia (MMC) card, a memory stick (MS) card, a secure digital high capacity (SDHC) card, and a M2 card) may expand the original limited storage capacity of the computer system. An external optical disk drive (ODD) and an optical disk recorder can expand a multimedia access function of the computer system and provide a large-capacity data backup function. A plurality of removable memory cards such as the SD card, the SDHC card, an extreme digital-picture (XD) card, the MMC card, and a memory stick (MS) card with standard specifications are developed. Many conventional memory cards mainly utilize a control chip to convert an electronic signal and transmit the electronic signal via an interface such as a universal serial bus (USB) interface, a PCI express (PCIE) interface, or a parallel advanced technology attachment (PATA) interface. However, the transmission speed of the electronic signal is not high due to the bus bandwidth of the USB interface, the PCIE interface, or the PATA interface and the definition of the interface. Furthermore, the conventional memory cards cannot provides large storage capacity due to their limited capacity.

### BRIEF SUMMARY OF THE INVENTION

The invention provides a memory card with a SATA connecter. The memory card with the SATA connecter includes a SATA connector used for being connected with an electronic device (such as a computer). The electronic device has a slot with a SATA connecter, and the slot is used for being connected with the SATA connector of the memory card. The SATA connector according to the invention includes nine pins, and the nine pins are used for receiving electric power, identifying a SATA interface signal, transmitting the SATA interface signal, and being connected with ground. The memory card further includes a memory module, a controller, and a power control circuit. The controller is electrically connected with the SATA connector and the memory module to control input and output of the SATA interface signal (the data transmission between the memory card and the electronic device). The power control circuit is electrically connected with the connector, the memory module, and the controller to provide the electric power needed by the memory card.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing the architecture that a memory card is externally connected with an electronic device according to an embodiment of the invention; and

FIG. 2 is an enlarged schematic diagram showing the memory card in FIG. 1 according to an embodiment of the invention.

### DETAILED DESCRIPTION OF THE EMBODIMENTS

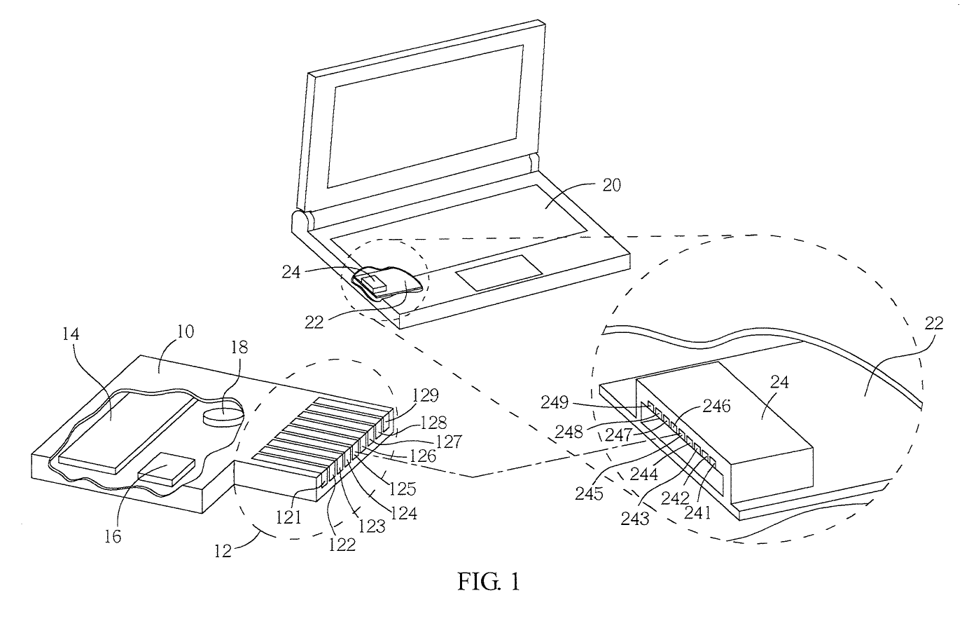

FIG. 1 is a schematic diagram showing the architecture that a memory card 10 is externally connected with an electronic device 20 according to an embodiment of the invention. A SATA connector is used as an interface of the memory card 10 for transmitting data with the electronic device 20. In this embodiment, the memory card 10 includes a SATA connector 12, a memory module 14, a controller 16, and a power control circuit 18. The SATA connector 12 is used for being electrically connected with a slot 24 with the SATA connecter of the electronic device 20 to transmit the data. The controller 16 is electrically connected with the SATA connector 12 and the memory module 14 to input or output a SATA interface signal. The power control circuit 18 is electrically connected with the SATA connector 12, the memory module 14, and the controller 16. The power control circuit 18 is used for providing the needed electric power for the memory card 10. In this embodiment, the SATA connector 12 is a connector with a SATA interface. The SATA connector 12 includes a first pin 121, a second pin 122, a third pin 123, a fourth pin 124, a fifth pin 125, a sixth pin 126, a seventh pin 127, an eighth pin 128, and a ninth pin 129. The nine pins are used for being electrically connected with a first terminal set 241, a second terminal set 242, a third terminal set 243, a fourth terminal set 244, a fifth terminal set 245, a sixth terminal set 246, a seventh terminal set 247, an eighth terminal set 248, and a ninth terminal set 249 in the slot 24 of the SATA connecter of the electronic device 20, respectively. Furthermore, the nine pins are used for receiving the electric power, identifying a SATA interface signal, transmitting the SATA interface signal, and being connected with ground. In this embodiment, in the SATA connecter of the memory card 10, one of the nine pins is used for receiving the electric power, one of the nine pins is used for identifying the SATA interface signal, two of the nine pins are used for transmitting differential signals of the SATA connecter, two of the nine pins are used for receiving the differential signals of the SATA connecter, and three of the nine pins are used for being connected with the ground.

The electronic device 20 (in this embodiment, the electronic device 20 may be a notebook computer) includes a circuit board 22 therein. The slot 24 of the SATA connecter is disposed on the circuit board 22. The slot 24 of the SATA connecter has nine terminal sets, and the nine terminal sets are used for receiving the electric power, identifying the SATA interface signal, transmitting the SATA interface signal, and being connected with the ground, respectively. The terminal sets and the connector of the memory card are correspondingly disposed. As stated above, the slot 24 of the SATA connecter includes the first terminal set 241, the second terminal set 242, the third terminal set 243, the fourth terminal set 244, the fifth terminal set 245, the sixth terminal set 246, the seventh terminal sett 247, the eighth terminal set 248, and the ninth terminal set 249.

The fourth pin 124 and the fifth pin 125 of the SATA connector 12 are used for transmitting the differential signal of the SATA connecter. The seventh pin 127 and the eighth pin 128 of the SATA connector 12 are used for receiving the differential signals of the SATA connecter. The lengths of the fourth pin 124, the fifth pin 125, the seventh pin 127, and the eighth pin 128 of the SATA connector 12 are slightly shorter than the lengths of the first pin 121, the second pin 122, the third pin 123, the sixth pin 126, and the ninth pin 129 of the SATA connector 12, respectively. Additionally, the operating voltage of the electric power received by the first pin 121 of the SATA connector 12 of the memory card 10 may be between +3.3V to +5V. When the memory card 10 is in the operating state, at least one of the third pin 123, the sixth pin 126, and the ninth pin 129 of the SATA connector 12 needs to be electrically connected with the third terminal set 243, the sixth terminal set 246, or the ninth terminal set 249 of the slot 24 of the SATA connecter, respectively, to be connected with the ground. The memory module 14 may be a flash memory.

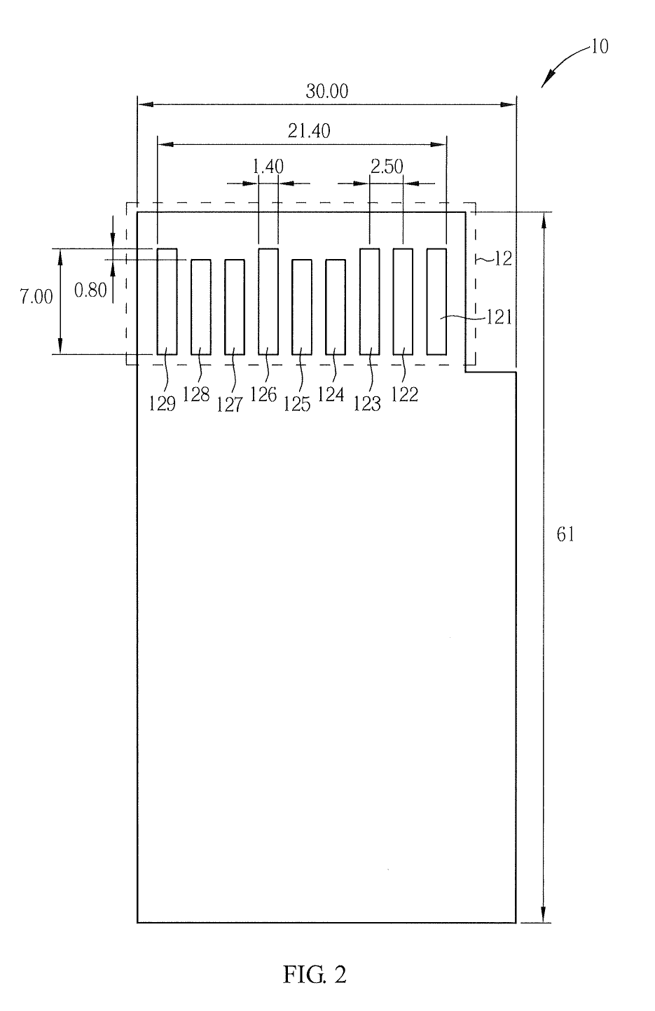

The structure and the size of the SATA connector 12 of the memory card 10 are illustrated in detail hereinafter. FIG. 2 is an enlarged schematic diagram showing the memory card 10 in FIG. 1 according to an embodiment of the invention. As shown in FIG, 2, the first pin 121, the second pin 122, the third pin 123, the fourth pin 124, the fifth pin 125, the sixth pin 126, the seventh pin 127, the eighth pin 128, and the ninth pin 129 are orderly disposed in the SATA connector 12. The length of the memory card 10 is 61 mm, the width of the memory card 10 is 30 mm, and error ranges of the length and the width of the memory card 10 are ±0.15 mm and ±0.05 mm, respectively, The distance between an outer edge of the first pin 121 and an outer edge of the ninth pin 129 is 21.4 mm. Furthermore, the lengths of the first pin 121, the second pin 122, the third pin 123, the sixth pin 126, and the ninth pin 129 are 7 mm, the widths of the first pin 121, the second pin 122, the third pin 123, the sixth pin 126, and the ninth pin 129 are 1.4 mm, respectively, and the error ranges of the lengths and the widths are ±0.10 mm and ±0.05 mm, respectively. The lengths of the fourth pin 124, the fifth pin 125, the seventh pin 127, and the eighth pin 128 are 6.2 mm, the widths of the fourth pin 124, the fifth pin 125, the seventh pin 127, and the eighth pin 128 are 1.4 mm, and the error ranges of the lengths and the widths are ±0.10 mm and ±0.05 mm, respectively. Additionally, the distances between a center axis of the first pin 121 and the center axis of the second pin 122, the center axis of the second pin 122 and the center axis of the third pin 123, the center axis of the third pin 123 and the center axis of the fourth pin 124, the center axis of the fourth pin 124 and the center axis of the fifth pin 125, the center axis of the fifth pin 125 and the center axis of the sixth pin 126, the center axis of the sixth pin 126 and the center axis of the seventh pin 127, the center axis of the seventh pin 127 and the center axis of the eighth pin 128, the center axis of the eighth pin 128 and the center axis of the ninth pin 129 are 2.5 mm, respectively.

In contrast with the conventional technology, the SATA connecter is used as a communication interface between the memory card and the slot of the electronic device according to the invention. The memory card still retains the appearance of an external plug-in memory card. The capacity of the memory module built in the memory card is increased, and the communication interface of the memory card is replaced by the SATA connecter provided with nine pins with specified arrangement, definitions, and sizes. As a result, the memory card which may transmit the SATA interface signal integrates large storage capacity and a high signal transmission speed, which are advantages of conventional hard disks. Furthermore, the memory card is light, small, and hot pluggable, which are the advantages of the memory card. Consequently, the memory card is easily operated, and the capacity of the memory card may be expanded.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A memory card with a serial advanced technology attachment (SATA) transmission interface, used for being connected with an electronic device, wherein the electronic device has a slot with a SATA connecter, the memory card comprising:
a SATA connector including a plurality of pins for receiving electric power, identifying a SATA interface signal, transmitting the SATA interface signal, and being connected with ground;
a memory module;
a controller electrically connected with the SATA connector and the memory module to control input and output of the SATA interface signal; and
a power control circuit electrically connected with the SATA connector, the memory module, and the controller to provide the electric power needed by the memory card.

2. The memory card according to claim 1, wherein the number of the pins is nine, one pin of the pins is used for receiving the electric power, and an operating voltage of the electric power received by the pin is between +3.3V to +5V.

3. The memory card according to claim 1, wherein one pin of the plurality of pins is used for identifying the SATA interface signal.

4. The memory card according to claim 1, wherein three pins of the plurality of pins are used for being connected with the ground.

5. The memory card according to claim 4, wherein when the memory card is in an operating state, at least one pin of the three pins is connected with the ground.

6. The memory card according to claim 1, wherein two pins of the plurality of pins are used for transmitting a differential signal of the SATA connecter.

7. The memory card according to claim 1, wherein two pins of the plurality of pins are used for receiving a differential signal of the SATA connecter.

8. The memory card according to claim 1, wherein the memory module is a flash memory.

9. A memory card with a SATA connecter, comprising:
an electronic device having a circuit board, wherein the circuit board includes a slot disposed on the circuit board, and the slot includes a plurality of terminal sets; and
a memory card including:
a connector used for being electrically connected with the slot, wherein the connector includes a plurality of pins, the pins are electrically connected with the terminal sets, respectively, and the pins are used for receiving electric power, identifying a SATA interface signal, transmitting the SATA interface signal, and being connected with ground, respectively;
a memory module;
a controller electrically connected with the connector and the memory module to control input and output of the SATA interface signal; and
a power control circuit electrically connected with the connector, the memory module, and the controller to provide the electric power needed by the memory card.

10. The memory card architecture according to claim 9, wherein the number of the pins is nine, one pin of the pins is used for receiving the electric power, and an operating voltage of the electric power received by the pin is between +3.3V to +5V.

11. The memory card architecture according to claim 9, wherein one pin of the plurality of pins is used for identifying the SATA interface signal.

12. The memory card architecture according to claim 9, wherein three pins of the plurality of pins are used for being connected with the ground.

13. The memory card architecture according to claim 12, wherein when the memory card is in an operating state, at least one pin of the three pins is connected with the ground.

14. The memory card architecture according to claim 9, wherein two pins of the plurality of pins are used for transmitting a differential signal of the SATA connecter.

15. The memory card architecture according to claim 9, wherein two pins of the plurality of pins are used for receiving a differential signal of the SATA connecter.

16. The memory card architecture according to claim 9, wherein the memory module is a flash memory.
